(19) United States
(12) Patent Application Publication
(10) Pub. No.: US 2012/0272471 A1
(43) Pub. Date: Nov. 1, 2012

(54) Wiper Arrangement and Method for Operating a Wiper Arrangement for a Motor Vehicle

(75) Inventors: Heiko Schmid, Oberriexingen (DE); Holger Fitterer, Rheinstetten (DE)

(73) Assignee: Daimler AG, Stuttgart (DE)

(21) Appl. No.: 13/516,975

(22) PCT Filed: Nov. 5, 2010
(86) PCT No.: PCT/EP2010/006755

§ 371 Date: Jul. 18, 2012

(30) Foreign Application Priority Data
Dec. 19, 2009 (DE) 10 2009 059 118.4

(51) Int. Cl. B60S 1/48

(52) U.S. Cl. 15/250.04

(57) ABSTRACT

A windscreen wiper system with an associated windscreen washer system for a motor vehicle is provided. The windscreen washer system includes a washer fluid supply line leading to outlets. The outlets are preferably provided on the wiper blade and are therefore capable of moving together with a corresponding wiper arm of the windscreen wiper system. A coupling part moving together with the moving wiper arm and connecting the wiper blade to the respective wiper arm is provided with changeover valves. An emergence of washer fluid from the outlets can be controlled by the changeover valves.

### BACKGROUND AND SUMMARY OF THE INVENTION

Exemplary embodiments of the present invention relate to a windscreen wiper system with an associated windscreen washer system for a motor vehicle. The windscreen washer system comprises a washer fluid supply line leading to at least one outlet, the at least one outlet being capable of moving together with a corresponding wiper arm of the windscreen wiper system. The invention further relates to a method for operating a windscreen wiper system of this type.

German Patent Document DE 36 43 476 A1 describes a reciprocating stroke wiper system of a motor vehicle in which nozzles for washer fluid, which are arranged on a wiper arm, are moved together with the wiper arm. A drive shaft of the wiper arm is provided with an axial bore that is divided into two independent delivery passages for the washer fluid by an axial separating web. By means of a gate provided in a connecting piece for connecting a flexible conduit, the washer fluid can be fed to either of the delivery passages. The delivery passages then lead to the nozzles. The gate is rotated with the pivoting movement of the drive shaft, which effects a reciprocating movement of the wiper arm. This ensures that the washer fluid is delivered to the nozzles that are positioned in front of the wiper arm as viewed in the wiping direction.

A windscreen washer system of this type has the disadvantage that the control of the emergence of washer fluid for the desired outlet is comparatively imprecise.

Exemplary embodiments of the present invention are directed to a windscreen wiper system and a method for operating such a windscreen wiper system that offer an improved control of the emergence of washer fluid from at least one of the outlets.

In the windscreen wiper system with an associated windscreen washer system for a motor vehicle according to the invention, the windscreen washer system comprises a washer fluid supply line that leads to at least one outlet. The at least one outlet is capable of moving together with a corresponding wiper arm of the windscreen wiper system. A component moving together with the moving wiper arm comprises a shut-off device by means of which an emergence of washer fluid from the at least one outlet can be controlled. The emergence of washer fluid from at least one of the outlets can therefore be enabled or disabled by means of the shut-off device moving together with the wiper arm. This enabling or disabling of the emergence of washer fluid in close proximity to the point of application of the washer fluid offers a particularly short response time. The emergence of washer fluid from at least one of the outlets can therefore be controlled in a particularly precise and demand-oriented manner.

This improves the cleaning action of the windscreen wiper system. It is further possible to reduce washer fluid consumption in this way, with the result that a particularly small washer fluid reservoir can be used. When arranging the windscreen wiper system in the motor vehicle, this reduces the overall weight of the motor vehicle and thus its emissions, in particular the carbon dioxide emission of the motor vehicle.

If comparatively little washer fluid is applied to a windscreen of a motor vehicle in a particularly well-aimed and precisely timed manner, very little washer fluid is drawn back by a wiper blade of the windscreen wiper system when the wiper arm has reached its reversing position and the wiping direction changes. Hardly any drawn-back washer fluid therefore reaches a region of the windscreen where this is undesirable. The effect on the field of view of the driver of the motor vehicle is therefore minimized.

The spread of inaccurately aimed and/or undesirably large amounts of washer fluid to windows close to the windscreen to be wiped, such as side windows and/or a roof of the motor vehicle, can therefore be largely avoided as well. The application of comparably little washer fluid to the windscreen to be cleaned has the further result that comparatively little washer fluid that would then drip onto undesirable points of the windscreen can be carried along by the wiper arm and/or the wiper blade and/or by a coupling part coupling the wiper arm and the wiper blade.

In an advantageous further development of the invention, the component is designed as a coupling part for coupling a wiper blade to the wiper arm. At this point, more space is available for the accommodation of the shut-off device than at other points of the wiper arm or the wiper blade. In addition, the at least one shut-off device is placed close to the desired point of washer fluid application, so that the time delay between the selection of the shut-off device and the emergence of washer fluid from the respective outlet is particularly short. When replacing the wiper blade, the coupling part can be replaced as well, so that a wear of lines carrying washer fluid in the region of the coupling part does not affect the functionality of the windscreen washer system.

It has further been shown to be advantageous if the at least one outlet is arranged on the wiper blade of the windscreen wiper system because if the washer fluid emerges onto the windscreen in the region of the wiper blade, the washer fluid can be used in a particularly well-aimed, precise and economical manner.

It is further advantageous if a first outlet is at least substantially oriented in one wiping direction and a second outlet is oriented in an opposite wiping direction. This makes it possible to apply washer fluid to the windscreen in the wiping direction via the first outlet. As the wiping direction of the wiper arm changes, washer fluid can then be applied to the windscreen via the second outlet.

In the case of a comparably dirty windscreen, it may be useful to use both outlets simultaneously, at least temporarily. It is also conceivable that the emergence of washer fluid from the first outlet oriented in the wiping direction could be blocked shortly before the wiper arm reaches its reversing position while allowing the emergence of wiper fluid from the second outlet by opening the shut-off device. This provides a particularly effective cleaning of the very dirty windscreen. An early application of washer fluid to the windscreen can soften stubborn dirt and therefore offer a better wiping result.

It is further advantageous if a branch-off point is provided in the component where the supply line divides into two distribution lines, each leading to an outlet. In this way, washer fluid can be applied to desired regions of the windscreen in a well-aimed manner.

Particularly short switching times can be achieved if the shut-off device is designed as a solenoid-operated switching element. The shut-off device further advantageously comprises a check valve, so that an undesirable return flow of washer fluid through the respective distribution line is prevented. By providing solenoid-operated switching elements at least two shut-off devices can be selected independently. Preferably all shut-off devices are independently selectable, so that the outlets through which washer fluid is to be applied to the windscreen can be precisely enabled, as required.

A particularly good wiping result can be obtained if the outlets are designed as nozzles distributed over a longitudinal section; this is combined with a particularly economical and efficient use of washer fluid. If the outlets are arranged on the wiper blade, the longitudinal section preferably extends along the longitudinal dimension of the wiper blade.

If the windscreen wiper system comprises two or more wiper arms, at least two distribution lines leading to respective outlets are advantageously assigned to one each of the wiper arms. In this case, a shut-off device is preferably provided for each distribution line. In this way, the outlets moving together with the driver-side wiper arm and with the passenger-side wiper arm can be enabled independently. Washer fluid can thereby be applied to an outlet oriented in the wiping direction on a driver-side wiper blade and on a passenger-side wiper blade by opening the respective shut-off device. In the same way, washer fluid can be applied to the windscreen against the wiping direction for the driver-side wiper arm and/or for the passenger-side wiper arm.

The lines can be routed in a particularly simple arrangement if a first supply line leading to a first wiper arm and a second supply line leading to a second wiper arm are coupled to a pumping device via a common line section.

In the method according to the invention for operating a windscreen wiper system, the washer fluid is fed via a supply line to at least one outlet, the at least one outlet being capable of moving together with a corresponding wiper arm of the windscreen wiper system. In this process, the washer fluid is introduced into a component capable of moving together with the wiper arm, wherein washer fluid emerges from the at least one outlet by opening a shut-off device provided in the component.

The advantages and preferred embodiment described for the windscreen wiper system according to the invention also apply to the method according to the invention for operating a windscreen wiper system.

The features and feature combinations mentioned in the above description and the features and feature combinations described below in the description of the figures and/or shown in the figures only can be used not only in the specified combination, but also in other combinations or individually without exceeding the scope of the invention.

### BRIEF DESCRIPTION OF THE DRAWING FIGURES

Further advantages, features and details of the invention can be derived from the claims, the following description of preferred embodiments and the drawings, in which identical elements or elements of identical function are identified by the same reference numbers. Of the drawing:

FIG. 1 shows some components of a windscreen wiper system for a motor vehicle, wherein an changeover valve for shutting off an outlet is provided in a coupling part by way of which a wiper blade is coupled to a wiper arm;

FIG. 2 shows a section through a wiper blade carrying washer fluid; and

FIG. 3 is an enlarged detailed view of components of a windscreen washer system according to FIG. 1.

### DETAILED DESCRIPTION

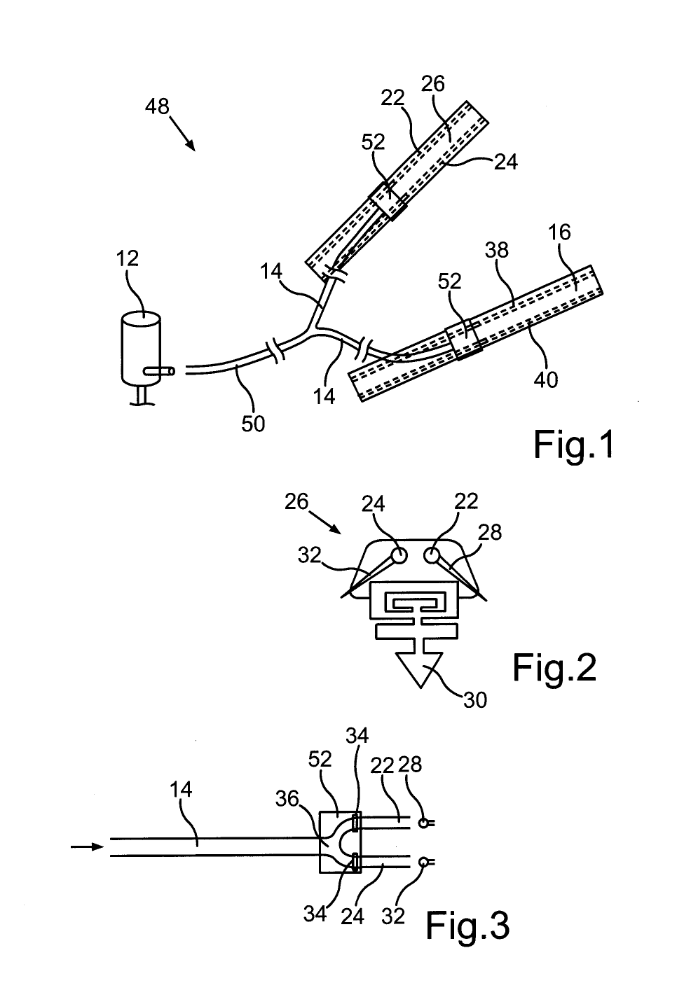

Of a windscreen wiper system 48 of a motor vehicle, FIG. 1 shows a pump 12 of a windscreen washer system that delivers washer fluid from a reservoir (not shown in the drawing). Of the windscreen wiper system 48, which comprises two wiper arms and wiper blades 16, 26 secured to the wiper arms, only the driver-side wiper blade 16 and the passenger-side wiper blade 26 are shown. The supply lines 14 leading to the wiper blades 16, 26 are connected to the pump 12 via a common line section 50. If the pump 12 builds up a defined washer fluid pressure in the common line section 50, this pressure is applied to the supply lines 14.

Each the wiper blades 16, 26 are coupled to the wiper arms (not shown in the drawing) via a coupling part 52. Each supply line 14 terminates into a coupling part 52 and branches there at a branch-off point 36 (cf. FIG. 3) to form two branch lines 22, 24, 38, 40 each. The distribution lines 22, 24 of the passenger-side wiper blade 26 extend on either side of a central longitudinal axis of the wiper blade 26. Washer fluid can be applied to a passenger-side region of the windscreen of the motor vehicle via these distribution lines 22, 24.

The driver-side wiper blade 16 has the same structure as the passenger-side wiper blade 26 (cf. FIG. 2), the two distribution lines 38, 40 of the driver-side wiper blade 16 leaving the coupling part 52 being used to apply washer fluid to a driver side of the windscreen. The distribution lines 22, 24, 38, 40 substantially extend along the entire length of the respective wiper blade 16, 26.

According to FIG. 2, a plurality of nozzles 28 are oriented substantially in one wiping direction of the wiper blade 26 away from the upper distribution line 22 routed through the wiper blade 26 if the wiper arm is moved into its upper reversing position. While the wiper arm is moved towards its upper reversing position, the washer fluid can be applied via these nozzles 28 to the region of the windscreen which is immediately in front of a blade rubber 30 of the wiper blade 26.

From the lower distribution line 24, which is routed through the wiper blade 26 in parallel with the upper distribution line 22, washer fluid can be applied via nozzles 32 oriented against this wiping direction to a region of the windscreen that is behind the blade rubber 30 in the wiping direction. When wiping with the wiper blade 26, however, the washer fluid is preferably applied via the nozzles 28, 32 to the windscreen in such a way that washer fluid is applied in each case to the region of the windscreen that is in front of the blade rubber 30.

Solenoid-operated changeover valves 34 (cf. FIG. 3) are provided in the coupling part 52 for switching between the distribution lines 22, 24 and thus between the associated nozzles 28, 32. The independently switchable changeover valves 34 are located downstream of the branch-off point 36 within the coupling part 52. Each of the changeover valves 34 allows the respective distribution line 22, 24 to be blocked or cleared. The changeover valves 34 provided in the coupling part 52 therefore allow a reversal of the direction of the spray jet, depending on whether the washer fluid emerges from the wiper blade 26 via the nozzles 28 or via the nozzles 32 (cf. FIG. 2). Each of the changeover valves 34 preferably includes an integrated check valve.

The two distribution lines 38, 40 in the driver-side wiper blade 16 likewise emerge from the coupling part 52 and extend on either side of a central longitudinal axis of the driver-side wiper blade 16. The coupling part 52 for connecting the driver-side wiper blade 16 to the driver-side wiper arm is also provided with a changeover valve 34 for each distribution line 38, 40.

Accordingly, by simultaneously opening the changeover valves 34 assigned to the distribution lines 22, 28, washer fluid can be applied to the region of the windscreen that is in front of the blade rubber 30 in the wiping direction while the wiper blades 16, 26 move towards their upper reversing position. The changeover from applying washer fluid to the windscreen via the distribution lines 22, 38 to applying washer fluid via the distribution lines 24, 40 can be made when the wiper arms and thus the wiper blades 16, 26 reach the reversing position or even shortly before the reversing position is reached.

If stubborn dirt and/or insects have to be removed from the windscreen it is possible to apply washer fluid simultaneously or at least with some time overlap both to regions of the windscreen that are in front of the blade rubber 30 in the wiping direction and, via the distribution lines 24, 40, to the regions of the windscreen which are behind the blade rubber 30 in the same wiping direction.

If the emergence of washer fluid from the nozzles 28 is already prevented by blocking the upper distribution line 22 before the wiper arm and the wiper blade 26 have reached their upper reversing position, and if washer fluid is at this point in time already applied to the windscreen via the lower distribution line 24 and thus via the nozzles 32, the washer fluid can act for a relatively long time and effectively soften any dirt.

The emergence of washer fluid from the passenger-side distribution lines 22, 24 and the driver-side distribution lines 38, 40 can be controlled separately owing to the independent selectability of the changeover valves 34 for the driver side and the passenger side. More washer fluid can then be applied to either side, possibly in dependence on the degree of local windscreen soiling.

Washer fluid can also be supplied independently to both the driver-side wiper blade 16 and the passenger-side wiper blade 26 and, within the respective wiper blade 16, 26, to the respective distribution lines 22, 24 and 38, 40.

The distribution of washer fluid between the distribution lines 22, 24 and 38, 40 that apply washer fluid to the windscreen in front of the blade rubber 30 in the wiping direction in the windscreen wiper system 48 is only carried out in the region where the respective wiper blade 16, 26 is connected to the wiper arm, i.e., in the coupling part 52. As a result, the response time between the selection of the respective changeover valve 34 and the emergence of washer fluid from the nozzles 28, 30 is short.

As the coupling part 52 is arranged centrally with respect to the longitudinal dimension of the respective wiper blade 16, 26, flow paths to the end nozzles 28, 32 on the wiper blade are approximately equal in length.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A system with a windscreen wiper system and an associated windscreen washer system, the system comprising:
a washer fluid supply line leading to at least one outlet, the at least one outlet configured to move together with a corresponding wiper arm of the windscreen wiper system; and
a component configured to move together with the moving wiper arm comprises a shut-off device, wherein the component is configured to control an emergence of washer fluid from the at least one outlet.

12. The system according to claim 11, wherein the component is a coupling part configured to couple a wiper blade to the wiper arm.

13. The system according to claim 11, wherein the at least one outlet is located on a wiper blade of the windscreen wiper system.

14. The system according to claim 11, wherein the at least one outlet includes a first outlet that is at least substantially oriented in one wiping direction and a second outlet that is oriented in an opposite wiping direction.

15. The system according to claim 14, wherein the component includes a branch-off point where the supply line is divided into two distribution lines each leading to a respective one of the first and second outlets.

16. The system according to claim 11, wherein the at least one shut-off device is a solenoid-operated switching element comprising a check valve.

17. The system according to claim 11, wherein the at least one outlet is a nozzle distributed over a longitudinal section.

18. The system according to claim 11, wherein the windscreen wiper system comprises at least two wiper arms, wherein two distribution lines leading to the respective outlets are assigned to each wiper arm.

19. The system according to claim 11, wherein a first supply line leading to a first wiper arm and a second supply line leading to a second wiper arm are coupled to a pumping device via a common line section.

20. A method for operating a windscreen wiper system with an associated windscreen washer system, the method comprising:
supplying washer fluid to at least one outlet via a supply line, the at least one outlet configured to move together with a corresponding wiper arm of the windscreen wiper system;
introducing the washer fluid into a component configured to move with the wiper arm; and
controlling emergence of washer fluid from the at least one outlet by opening a shut-off device provided in the component.
